(19) United States
(12) Patent Application Publication
(10) Pub. No.: US 2022/0379974 A1
(43) Pub. Date: Dec. 1, 2022

(54) VEHICLE REAR STRUCTURE

(71) Applicant: HONDA MOTOR CO., LTD., Tokyo (JP)

(72) Inventors: Takashi Nitta, Tokyo (JP); Kazuya Kimura, Tokyo (JP)

(21) Appl. No.: 17/751,825

(22) Filed: May 24, 2022

(30) Foreign Application Priority Data
May 26, 2021 (JP) 2021-088043

(51) Int. Cl. B62D 25/20; B62D 21/15

(52) U.S. Cl. CPC B62D 25/2036; B62D 21/152; B62D 25/2027

(57) ABSTRACT

This vehicle rear structure includes a rear floor pan, rear side frames each provided on an outer side of the rear floor pan in a vehicle width direction, and a cross portion configured to connect the rear side frames provided on both sides in the vehicle width direction, and the cross portion has a cross ridge portion provided in front of the rear floor pan and extending in the vehicle width direction, and an extension member having a first end portion connected to the cross ridge portion and a second end portion disposed at a side opposite to the first end portion in the vehicle width direction and connected to the rear side frames.

### CROSS-REFERENCE TO RELATED APPLICATION

The present application claims priority based on Japanese Patent Application No. 2021-088043, filed May 26, 2021, the content of which is incorporated herein by reference.

### BACKGROUND OF THE INVENTION

### Field of the Invention

The present invention relates to a vehicle rear structure.

### Description of Related Art

In the related art, a vehicle rear structure in which a rear cross member is configured to join a pair of side frames and is disposed on a lower surface side of a rear floor and in front of a spare tire housing is known (for example, see Japanese Unexamined Patent Application, First Publication No. 2011-131712).

### SUMMARY OF THE INVENTION

However, in the vehicle rear structure disclosed in Japanese Unexamined Patent Application, First Publication No. 2011-131712, since the cross member is provided throughout the entire region in a vehicle width direction, the vehicle rear structure becomes heavier, and the weight of the entire vehicle may become heavier accordingly. In addition, in the vehicle rear structure disclosed in Japanese Unexamined Patent Application, First Publication No. 2011-131712, since the cross member is provided throughout the entire region in the vehicle width direction, manufacturing costs may be increased.

An aspect of the present invention is directed to providing a vehicle rear structure capable of being reduced in weight and minimizing manufacturing costs.

In order to accomplish the above-mentioned purposes, a vehicle rear structure according to the aspect of the present invention employs the following configurations.

(1) An aspect of the present invention is a vehicle rear structure including: a rear floor pan (for example, an example of a rear floor pan (2) of an embodiment); rear side frames (for example, an example of rear side frames (3) of the embodiment) each provided on an outer side of the rear floor pan in a vehicle width direction; and a cross portion (for example, an example of a cross portion (4) of the embodiment) configured to connect the rear side frames provided on both sides in the vehicle width direction, wherein the cross portion has: a cross ridge portion (for example, an example of a cross ridge portion (41) of the embodiment) provided in front of the rear floor pan and extending in the vehicle width direction; and an extension member (for example, an example of an extension member (42) of the embodiment) having a first end portion connected to the cross ridge portion and a second end portion disposed at a side opposite to the first end portion in the vehicle width direction and connected to the rear side frames.

(2) In the aspect of the above-mentioned (1), the extension member may have: a bottom wall (for example, an example of a bottom wall (45) of the embodiment) facing in an upward/downward direction; a front sidewall (for example, an example of a front sidewall (46) of the embodiment) located in front of the bottom wall and standing up in the upward/downward direction; and a first extension ridge portion (for example, an example of a first extension ridge portion (47) of the embodiment) configured to connect the bottom wall and the front sidewall and extending in the vehicle width direction, and the cross ridge portion and the first extension ridge portion may be provided continuously in the vehicle width direction.

(3) In the aspect of the above-mentioned (1) or (2), a reinforcement member (for example, an example of a reinforcement member (6) of the embodiment) may be provided at a position facing the extension member with the rear floor pan sandwiched therebetween.

(4) In the aspect of the above-mentioned (2), a suspension receiving portion (for example, an example of a suspension receiving portion (5) of the embodiment) to which an upper end portion of a suspension is connected may be provided on the rear side frames, and the suspension receiving portion may overlap the first extension ridge portion in the upward/downward direction.

(5) In the aspect of the above-mentioned (2), the extension member may further have:

a rear sidewall (for example, an example of a rear sidewall (48) of the embodiment) located behind the bottom wall and standing up in the upward/downward direction; and a second extension ridge portion (for example, an example of a second extension ridge portion (49) of the embodiment) configured to connect the bottom wall and the rear sidewall and extending in the vehicle width direction, and the second extension ridge portion may be continuously provided on side surfaces (for example, an example of side surfaces (22a) of the embodiment) provided on sides of the rear floor pan.

According to the aspect of the above-mentioned (1), the cross portion has the cross ridge portion and the extension member. A pseudo-cross member can be formed by the cross portion. Since the cross portion has the cross ridge portion provided in front of the rear floor pan and extending in the vehicle width direction, the cross ridge portion can be used as an alternative to the cross member. In addition, since the cross portion has the extension member, the cross ridge portion can be further reinforced. For this reason, the cross members that cross the vehicle width direction are no longer required, and manufacturing costs can be minimized while the weight of the vehicle is reduced.

According to the aspect of the above-mentioned (2), since the cross ridge portion and the first extension ridge portion are continuous in the vehicle width direction, it is possible to more efficiently receive a load with respect to the vehicle rear structure while improving strength of the cross portion.

According to the aspect of the above-mentioned (3), since the reinforcement member is provided, rigidity of the cross portion can be further improved. For this reason, when a load is applied to the vehicle rear structure, deformation of the joining portion joining the rear floor pan (2) and the rear side frames (3) to the cross portion (4) can be minimized.

According to the aspect of the above-mentioned (4), since the suspension receiving portion (5) is provided, strength of the connecting portion between the extension member (42) and the rear side frames (3) can be improved. For this reason, it is possible to minimize deformation of the outer end portion (second end portion (52)) of the cross portion (4), and receive a load using the entire pseudo-cross member.

According to the aspect of the above-mentioned (5), since the second extension ridge portion (49) is provided, in the vehicle width direction, strength of the connecting portion between the rear floor pan (2) and the extension member (42) can be improved. For this reason, it is possible to more efficiently receive a load with respect to a vehicle rear structure (1) while improving strength of a cross portion (4).

### BRIEF DESCRIPTION OF THE DRAWINGS

FIG. 1 is a plan view showing a vehicle rear structure according to an embodiment of the present invention from below.

FIG. 2 is an enlarged view of a portion II of FIG. 1.

FIG. 3 is a plan view showing a portion III of FIG. 1 from above.

### DESCRIPTION OF EMBODIMENTS

Hereinafter, an embodiment of the present invention will be described with reference to the accompanying drawings. In the drawings used in the following description, in order to make features easier to understand, for convenience, characteristic portions may be shown enlarged, and shapes, dimensional ratios, or the like, of components are not limited to those shown.

### <Vehicle Rear Structure>

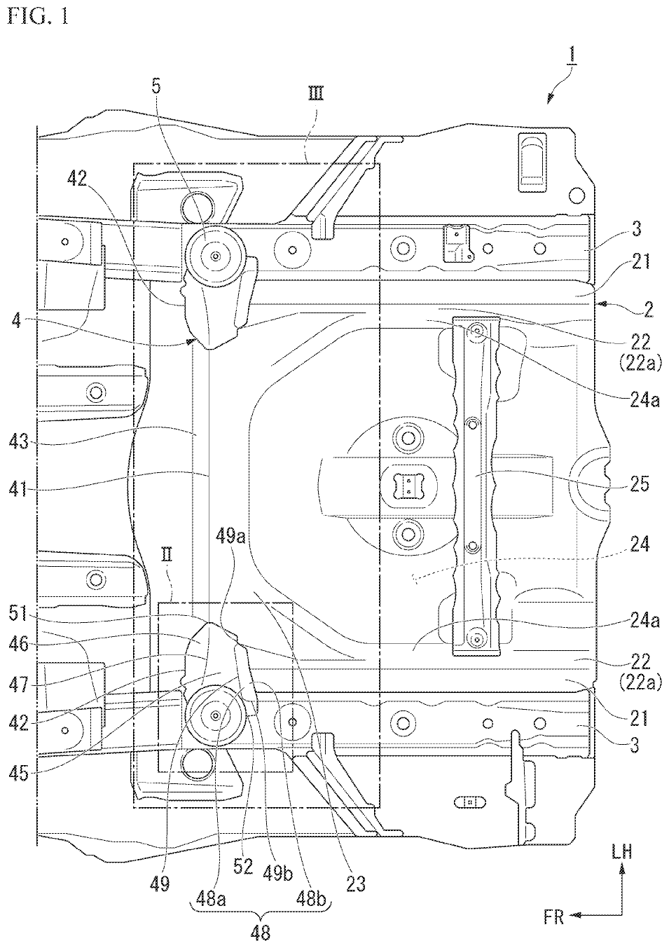

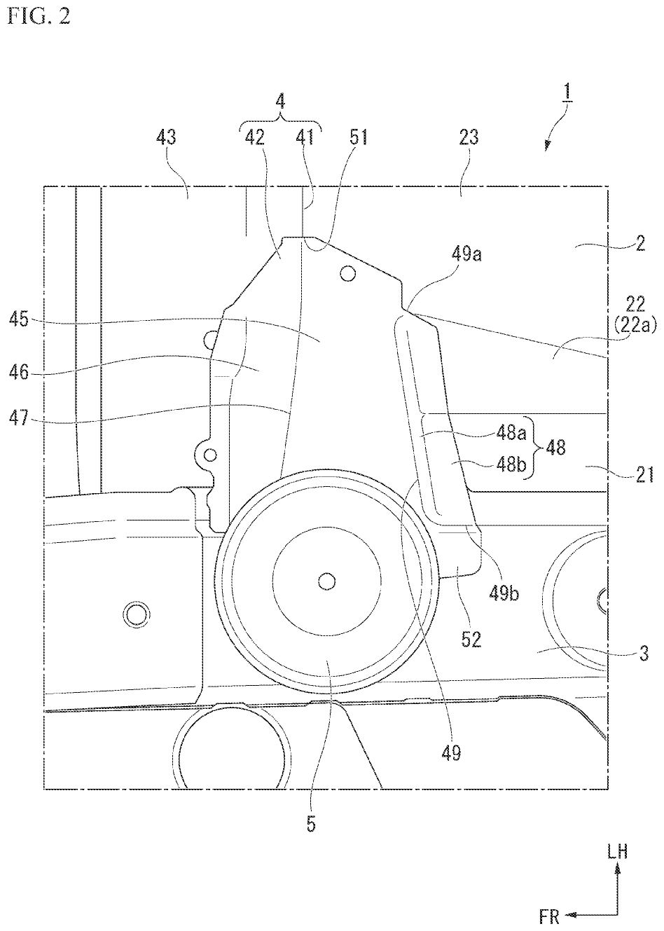

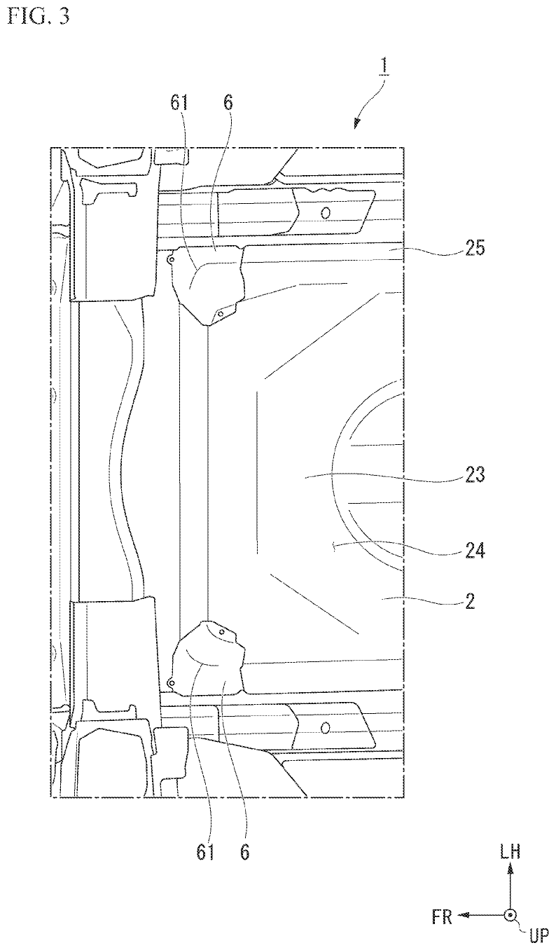

FIG. 1 is a plan view showing a vehicle rear structure 1 from below. FIG. 2 is an enlarged view of a portion II of FIG. 1. FIG. 3 is a plan view showing a portion III of FIG. 1 from above. FIGS. 1 to 3 partially show the vehicle rear structure 1.

In FIGS. 1 to 3, an arrow FR indicates a forward direction of a vehicle, an arrow UP indicates an upward direction of the vehicle, and an arrow LH indicates a leftward direction of the vehicle (a leftward direction of a passenger). In addition, directions of forward, rearward, upward, downward, leftward and rightward are oriented with respect to the vehicle.

The vehicle rear structure 1 is applied to, for example, a vehicle in which a passenger compartment that an occupant enters, and a cargo compartment located behind the passenger compartment (neither is shown) are separately provided. The vehicle rear structure 1 is provided on the side of the cargo compartment. The vehicle rear structure 1 is a member that constitutes a frame of a vehicle body. The vehicle rear structure 1 has a rear floor pan 2, rear side frames 3, a cross portion 4, a suspension receiving portion 5, and a reinforcement member 6 (see FIG. 3).

The rear floor pan 2 is provided on a rear portion and a lower portion of the vehicle, and configures a floor surface of the cargo compartment. The rear floor pan 2 has a pair of outer rear floor bottom portions 21, a pair of rear floor sidewall portions 22, and an inner rear floor bottom portion 23. The outer rear floor bottom portions 21, the rear floor sidewall portions 22, and the inner rear floor bottom portion 23 are formed by pressing a plate-shaped member.

The outer rear floor bottom portions 21 are provided on outer sides of the rear floor pan 2 in a vehicle width direction. The outer rear floor bottom portions 21 are provided in the forward/rearward direction.

The pair of rear floor sidewall portions 22 are provided on an inner side of the pair of outer rear floor bottom portions 21 in the vehicle width direction. An area between the rear floor sidewall portions 22 and the outer rear floor bottom portions 21 is smoothly continuous. The rear floor sidewall portions 22 are provided in the forward/rearward direction. The rear floor sidewall portions 22 are inclined downward and inward in the vehicle width direction.

The rear floor sidewall portions 22 have side surfaces 22a facing outward in the vehicle width direction.

The inner rear floor bottom portion 23 is provided on inner sides of the pair of rear floor sidewall portions 22 in the vehicle width direction. The inner rear floor bottom portion 23 faces in an upward/downward direction.

An accommodating concave portion 24 protruding downward is provided in the inner rear floor bottom portion 23. The accommodating concave portion 24 is a space capable of accommodating a spare tire, tools, or the like. The accommodating concave portion 24 gradually narrows forward. Sidewalls 24a facing in the vehicle width direction while surrounding the accommodating concave portion 24 are smoothly continuous with the rear floor sidewall portions 22.

A cross member 25 is provided on a lower surface of the inner rear floor bottom portion 23. The cross member 25 is fixed to the lower surface of the inner rear floor bottom portion 23 through welding. The cross member 25 is a rectangular member in which a longitudinal direction is parallel to the vehicle width direction. Since the cross member 25 is provided, strength of the inner rear floor bottom portion 23 can be improved.

The rear side frames 3 are provided on lower surfaces of the outer rear floor bottom portions 21. In the embodiment, the rear side frames 3 are each provided on the pair of outer rear floor bottom portions 21 located on the outer sides in the vehicle width direction.

The rear side frames 3 are fixed to the lower surfaces of the outer rear floor bottom portions 21 through welding. The rear side frames 3 are provided in the forward/rearward direction like the outer rear floor bottom portions 21. Front ends of the rear side frames 3 are located in front of the rear floor pan 2.

The cross portion 4 functions as a pseudo-cross member and is provided in front of the rear floor pan 2. The cross portion 4 connects the rear side frames 3 provided on both sides in the vehicle width direction. The cross portion 4 has a cross ridge portion 41, and an extension member 42.

The cross ridge portion 41 is provided in front of the rear floor pan 2 and extends in the vehicle width direction. The cross ridge portion 41 is formed integrally with the rear floor pan 2. A cross sidewall portion 43 is provided in front of the cross ridge portion 41.

The cross sidewall portion 43 extends in the vehicle width direction. The cross sidewall portion 43 faces in the forward/rearward direction. The cross sidewall portion 43 is inclined rearward as it goes downward.

The cross ridge portion 41 is provided between the cross sidewall portion 43 and the inner rear floor bottom portion 23. Specifically, the cross ridge portion 41 is a ridge portion that is smoothly connected from a front end of the inner rear floor bottom portion 23 to a lower end of the cross sidewall portion 43 while being curved.

The extension members 42 are each provided on both left and right ends of the cross ridge portion 41. The extension members 42 are fixed to the rear floor pan 2 or the lower surfaces of the rear side frames 3 through welding.

The extension member 42 has a bottom wall 45, a front sidewall 46, a first extension ridge portion 47, a rear sidewall 48, and a second extension ridge portion 49. The bottom wall 45, the front sidewall 46, the first extension ridge portion 47, the rear sidewall 48, and the second extension ridge portion 49 are formed by pressing a plate-shaped member.

In the following description, in the extension member 42, an end portion located on the innermost side in the vehicle width direction is referred to as a first end portion 51, and an end portion located on the outermost side (an end portion opposite to the first end portion 51) is referred to as a second end portion 52.

The bottom wall 45 faces in the upward/downward direction. The bottom wall 45 has the second end portion 52. The second end portion 52 is provided in the forward/rearward direction. The second end portion 52 is connected to the rear side frames 3.

The front sidewall 46 is located in front of the bottom wall 45, and stands up in the upward/downward direction. The front sidewall 46 is smoothly and continuously provided on the cross sidewall portion 43.

The first extension ridge portion 47 is provided between the bottom wall 45 and the front sidewall 46, and smoothly connects the bottom wall 45 and the front sidewall 46. The first extension ridge portion 47 extends in the vehicle width direction. The first extension ridge portion 47 has the first end portion 51. The first end portion 51 is connected to the cross ridge portion 41. Specifically, the first end portion 51 is smoothly connected to an outer end portion of the cross ridge portion 41 in the vehicle width direction.

The first extension ridge portion 47 is curved slightly forward as it goes outward from the first end portion 51 in the vehicle width direction when seen in a plan view. The first extension ridge portion 47 is provided continuously with the cross ridge portion 41 in the vehicle width direction. The first extension ridge portion 47 and the cross ridge portion 41 form a series of ridge portions in the vehicle width direction.

The rear sidewall 48 is located behind the bottom wall 45. The rear sidewall 48 has a raised portion 48a and a rib 48b. The raised portion 48a stands up in the upward/downward direction with respect to the rear floor pan 2. The rib 48b is provided behind the raised portion 48a. The rib 48b is provided continuously with the raised portion 48a with a fixed width in the forward/rearward direction. The rib 48b is provided along the lower surface of the rear floor pan 2. Specifically, the rib 48b is provided along the lower surfaces of the outer rear floor bottom portions 21 and the side surfaces 22a of the rear floor sidewall portions 22 in the rear floor pan 2.

The second extension ridge portion 49 is provided between the bottom wall 45 and the rear sidewall 48, and smoothly connects the bottom wall 45 and the rear sidewall 48. The second extension ridge portion 49 extends in the vehicle width direction.

In the second extension ridge portion 49, an inner end portion 49a located on the inner side in the vehicle width direction is curved rearward from the vehicle width direction when seen in a plan view. The second extension ridge portion 49 is provided continuously with the side surfaces 22a of the rear floor sidewall portions 22. Specifically, in the second extension ridge portion 49, the inner end portion 49a located on the inner side in the vehicle width direction is continuous with the front end portions and the lower end portions of the side surfaces 22a provided in the rear floor sidewall portions 22. The inner end portion 49a is provided with no gap with respect to the rear floor pan 2 in the upward/downward direction.

In the second extension ridge portion 49, an outer end portion 49b located on the outer side in the vehicle width direction is curved outward from the vehicle width direction when seen in a plan view. The outer end portion 49b is provided at a position overlapping the rear side frames 3 in the upward/downward direction. The outer end portion 49b is provided with no gap with respect to the rear side frames 3 in the upward/downward direction.

The suspension receiving portions 5 are provided on the pair of rear side frames 3, respectively. The suspension receiving portion 5 overlaps the second end portion 52 of the extension member 42 when seen in a plan view. The suspension receiving portion 5 is connected to an upper end portion of a suspension (not shown). The suspension receiving portion 5 is a circular member when seen in a plan view. A diameter of the suspension receiving portion 5 is provided with the same length as the width of the rear side frames 3 in the vehicle width direction when seen in a plan view.

The suspension receiving portion 5 overlaps the first extension ridge portion 47 in the upward/downward direction. Specifically, an outer end portion of the first extension ridge portion 47 in the vehicle width direction is sandwiched between the rear side frames 3 and the suspension receiving portion 5.

The reinforcement member 6 is provided on the upper surface of the rear floor pan 2. Specifically, the reinforcement member 6 is provided at a position facing the extension member 42 with the rear floor pan 2 sandwiched therebetween. The reinforcement member 6 is formed by pressing a plate-shaped member. The reinforcement member 6 is formed along a shape of the facing rear floor pan 2. As shown in FIG. 3, the reinforcement member 6 has a corner portion 61 overlapping a portion where the inner rear floor bottom portion 23, the rear floor sidewall portions 22 and the cross ridge portion 41 cross each other in the upward/downward direction.

### <Effects>

Hereinafter, effects of the embodiment will be described.

In the embodiment, the cross portion 4 has the cross ridge portion 41 and the extension member 42. A pseudo-cross member can be formed by the cross portion 4. Since the cross portion 4 has the cross ridge portion 41 provided in front of the rear floor pan 2 and extending in the vehicle width direction, the cross ridge portion 41 can be used as an alternative to the cross member. In addition, since the cross portion 4 has the extension member 42, the cross ridge portion 41 can be further reinforced. For this reason, cross members that cross the vehicle width direction are no longer required, and thus, it is possible to minimize manufacturing costs while reducing the weight of the vehicle.

In the embodiment, since the cross ridge portion 41 and the first extension ridge portion 47 are continuous in the vehicle width direction, it is possible to more efficiently receive a load with respect to the vehicle rear structure 1 while improving strength of the cross portion 4.

In the embodiment, since the reinforcement member 6 is provided, rigidity of the cross portion 4 can be further improved. For this reason, when a load is applied to the vehicle rear structure 1, it is possible to minimize deformation of the joining portion of the rear floor pan 2 and the rear side frames 3 to the cross portion 4.

In the embodiment, since the suspension receiving portion is provided, it is possible to improve strength of the connecting portion between the extension member and the rear side frames. For this reason, it is possible to minimize deformation of the outer end portion (second end portion) of the cross portion and receive a load using the entire pseudo-cross member.

In the embodiment, since the second extension ridge portion is provided, it is possible to improve strength of the connecting portion between the rear floor pan and the extension member in the vehicle width direction. For this reason, it is possible to more efficiently receive a load with respect to the vehicle rear structure while improving strength of the cross portion.

### <Modification Example>

Hereinabove, while the preferred embodiment of the present invention has been described, the present invention is not limited to the embodiment. Additions, omissions, substitutions and other changes of the components may be made without departing from the spirit of the present invention. The present invention is not limited to the above-mentioned description, and is limited by only the range of the accompanying claims.

In the above-mentioned embodiment, the configuration in which the reinforcement member 6 is provided has been described, there is no limitation thereto. The reinforcement member 6 may be provided as needed.

1.-5. (canceled)

6. A vehicle rear structure comprising:
a rear floor pan;
rear side frames each provided on an outer side of the rear floor pan in a vehicle width direction; and
a cross portion configured to connect the rear side frames provided on both sides in the vehicle width direction,
wherein the cross portion has:
a cross ridge portion provided in front of the rear floor pan and extending in the vehicle width direction; and
an extension member having a first end portion connected to the cross ridge portion and a second end portion disposed at a side opposite to the first end portion in the vehicle width direction and connected to the rear side frames.

7. The vehicle rear structure according to claim 6, wherein the extension member has:
a bottom wall facing in an upward/downward direction;
a front sidewall located in front of the bottom wall and standing up in the upward/downward direction; and
a first extension ridge portion configured to connect the bottom wall and the front sidewall and extending in the vehicle width direction, and
the cross ridge portion and the first extension ridge portion are provided continuously in the vehicle width direction.

8. The vehicle rear structure according to claim 6, wherein a reinforcement member is provided at a position facing the extension member with the rear floor pan sandwiched therebetween.

9. The vehicle rear structure according to claim 7, wherein a reinforcement member is provided at a position facing the extension member with the rear floor pan sandwiched therebetween.

10. The vehicle rear structure according to claim 7, wherein a suspension receiving portion to which an upper end portion of a suspension is connected is provided on the rear side frames, and
the suspension receiving portion overlaps the first extension ridge portion in the upward/downward direction.

11. The vehicle rear structure according to claim 7, wherein the extension member further has:
a rear sidewall located behind the bottom wall and standing up in the upward/downward direction; and
a second extension ridge portion configured to connect the bottom wall and the rear sidewall and extending in the vehicle width direction, and
the second extension ridge portion is continuously provided on side surfaces provided on sides of the rear floor pan.
